(19) United States
(12) Patent Application Publication
(10) Pub. No.: US 2013/0146426 A1
(43) Pub. Date: Jun. 13, 2013

(54) Anti-corosive light weight rollers for conveyor systems

(71) Applicants: Pranesh Raghunath Dhond, Goa (IN); Vishram Yeshwant Dhond, Goa (IN)

(72) Inventors: Pranesh Raghunath Dhond, Goa (IN); Vishram Yeshwant Dhond, Goa (IN)

(21) Appl. No.: 13/573,024

(22) Filed: Aug. 13, 2012

(30) Foreign Application Priority Data
Dec. 8, 2011 (IN) 3457/MUM/2011A

(51) Int. Cl. B65G 23/04

(52) U.S. Cl. 198/835

(57) ABSTRACT

A light weight, non-stick, corrosion and wear resistant roller in conveyor systems is provided. The roller is moulded out of an engineering polymer material through screw extruder by formation of a barrel with grooves throughout the length embedded with a shaft of glass reinforced material.

### TECHNICAL FIELD

The present disclosure relates to roller elements provided in conveyor systems.

### BACKGROUND

A conventional solid conveying system uses metal rollers made as per, for example, IS 8598 on a carrying side that is normally troughed, which on a return side is configured as either a “V” type arrangement or straight rollers.

The function of the rollers is to support the conveyor belts. As the conveyor carries weight of material conveyed, due to the weight, the conveyor belt is bound to sag hampering the conveying system. To prevent belt sag, rollers are intermittently provided throughout the conveyor system length. The rollers on a carrying side are usually troughed with varying degrees of troughing angles, and are placed at a pitch of 1 to 1.2 m, whereas rollers on a return side are either plain or ‘V’ shaped, and are placed at a longer pitch, such as, for example, 3 meters.

As is well known, the conveyor belt moves using principles of friction. One of the rollers, such as a drum roller, is operatively connected to a prime mover, such as, for example, a motor (and Gear box called Drive unit), or the like. As the belt moves, all other rollers will move. A fraction of the power given to the belt is used in driving the rollers. If the rollers are heavy, inertia is greater, and greater power is required to start rotation of the rollers, and subsequently to keep them rotating at belt speed.

It is also known to use garland type rollers on both a carrying side and a return side of the belt conveying system. The latest known concept involves use of a tube/pipe conveyor that forms an enclosure around the material to be conveyed.

All such conveyor systems require rollers to support or form a pipe, in the case of a pipe conveyor. Power reduction requirements are a major factor in designing the belt conveying system.

Leakage of material on conveyor belts causes material to stick on rollers, which leads to rapid deterioration of the conveyor belt. Wear and tear on metal rollers also leads to wear and tear on the belts, or damage to the top/bottom rubber layer of conveyor belts.

Corrosion of rollers and shaft in harsh chemical environments reduces roller life to a great extent, which necessitates providing corrosion and wear resistant treatments and coatings, such as, for example, rubber lining, galvanizing, or epoxy painting, which increase the roller life marginally. Corrosion and wear resistant treatments and coatings are expensive in conveyor applications, and also increases manufacturing costs for the systems.

Presently, rollers for conveyor systems are made of steel pipe, steel housing, ball bearing with nylon seals, and steel shaft. These materials increase the overall weight of the roller, and also the rolling mass is greater because of the steel pipe roller shell and steel housings at the ends of bearings. Higher rotational mass has higher inertia, and so higher starting torque is required to rotate the rollers, and subsequently to bring it to the speeds to match the belt speed. This increases power requirements during startup, and higher rotating mass inertia results in higher consumption of power.

The weight and construction of belt systems plays a critical role in the total power requirement of the conveyor system. In other words, reducing the weight of the system reduces the inertia and power required for the same system of conveying.

### SUMMARY

An embodiment of a system constructed in accordance with the principles herein provides for non-stick, corrosion resistant and wear resistant rotating elements without affecting the other operational characteristics of the rotating elements of the system.

Embodiments of system constructed in accordance with the principles herein provide the conveyor industry with a modern high tech material product which is light in weight, low on power consumption, and easy to fit or replace lesser power requirements, lesser carbon foot print and thus employs concepts of green technology.

The low coefficient of friction results from the use of the engineering polymer ultra-high-molecular-weight polyethylene (UHMWPE) used in accordance with the principles herein in forming shells of rollers, which reduces wear on both the roller and the belt. Reducing the weight of the rollers means reduced inertia and so reduced starting torque or reduced input power requirement, which results in reduced power consumption.

The non-stick properties of the roller material keep the underside of the belt clean, increasing the useful life of the belt. The roller material is relatively softer than the belt, hence no damage to the belt occurs when the roller gets worn out. Further, no tearing of the belt occurs due to worn out rollers.

One of the objectives of the present disclosure is to reduce the weight of the rollers to make the supporting structure of the conveying system lighter. The reduced weight leads to reduced inertia and consequently power savings ranging from about 18 to 24% depending upon the length of the belt conveyor. Reduced structural cost of the basic conveyor due to reduced weight results in reduced cost of the foundation and construction of a system constructed in accordance with the principles herein.

Antistatic properties and non-sticking properties of the rollers reduce sticking problems, which further prevent belt wandering. The material is highly abrasion-resistant and has very low coefficients of friction, which reduce the belt and the roller wear drastically. Since the weight of the roller shell is very low and out of roundness is reduced, unbalanced loads and vibration are low, leading to an increase in the bearing life and consequently the life of rollers.

The material for the shaft is a composite material made of resin and glass fiber protruded in special equipment, which ensures dimensional tolerance and straightness. Since the density of the material is very low, the overall weight of the roller is reduced to a great extent. It has been observed during experimentation that the strength of the shaft is comparable with that of a steel shaft.

The present disclosure therefore envisages providing light weight, non-stick, corrosion and wear-resistant rollers in embodiments of conveyor systems. A suitable roller envisaged according to the present disclosure is moulded of an engineering polymer material and a glass reinforced material for a shaft constructed in accordance with the principles herein, reducing the total weight of the roller. The reduced weight roller results in reduced inertia of rotating elements, reduced overall weight and hence reduced weight of the supporting structure, reduced input power requirements and eliminates material build up on rotating parts.

In an embodiment the polymer material is made to contain antistatic properties by adding suitable chemicals, such as, for example, activated carbon black during compounding of a raw material used in production of both pipes and roller shells.

The roller shaft is formed out of composite material made of resin and glass fiber protruded in special equipment, which ensures dimensional tolerance and straightness.

### BRIEF DESCRIPTION OF THE DRAWINGS

FIG. 1 illustrates a side elevational overall view of an exemplary conveyor system constructed in accordance with the principles herein.

FIG. 2 illustrates a front elevational view of an exemplary roller and frame constructed in accordance with the principles herein.

FIG. 3 illustrates a top elevational view of a conveyor roller.

FIG. 4 illustrates a side elevational view of the roller of FIG. 2.

FIG. 5 illustrates a roller shaft constructed in accordance with the principles herein.

### DETAILED DESCRIPTION

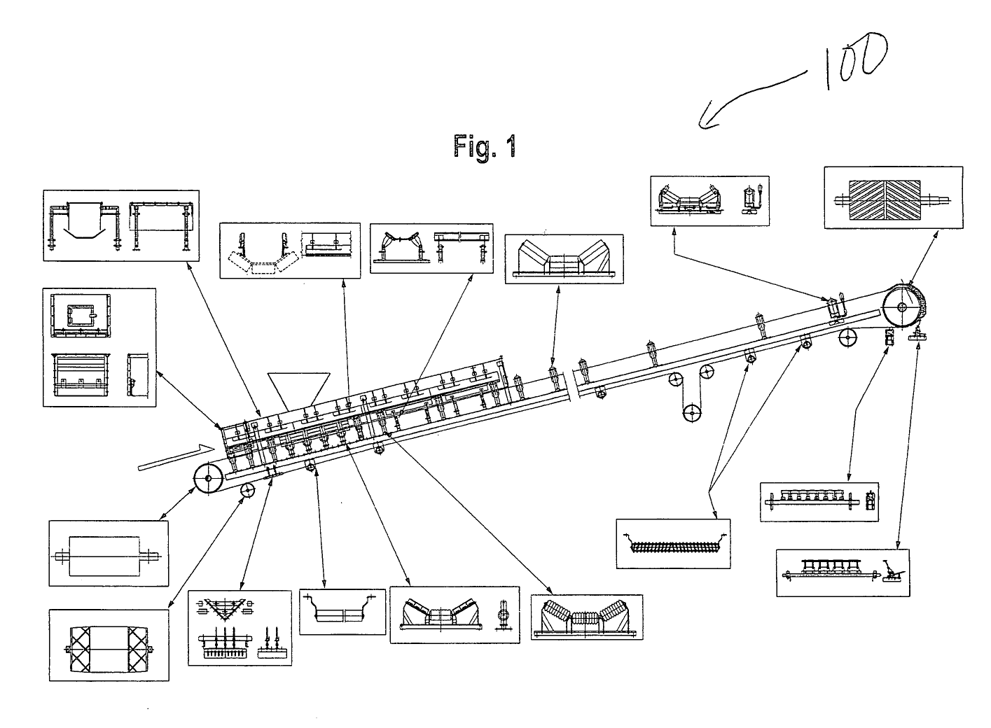

Conveyor rollers used in belt conveyors, such as the exemplary belt conveyor shown generally at 100 in FIG. 1 and constructed in accordance with the principles herein can be formed using a suitable lightweight material, such as, for example, the engineering polymer UHMWPE. The UHMWPE material has a low coefficient of friction, outstanding abrasion resistance, superior impact resistance, chemical and alkali resistance, self lubricating properties and excellent mechanical properties, even in cryogenic conditions. It has very low density of 0.93 gm/cc compared to that of steel which is 7.8 gm/cc.

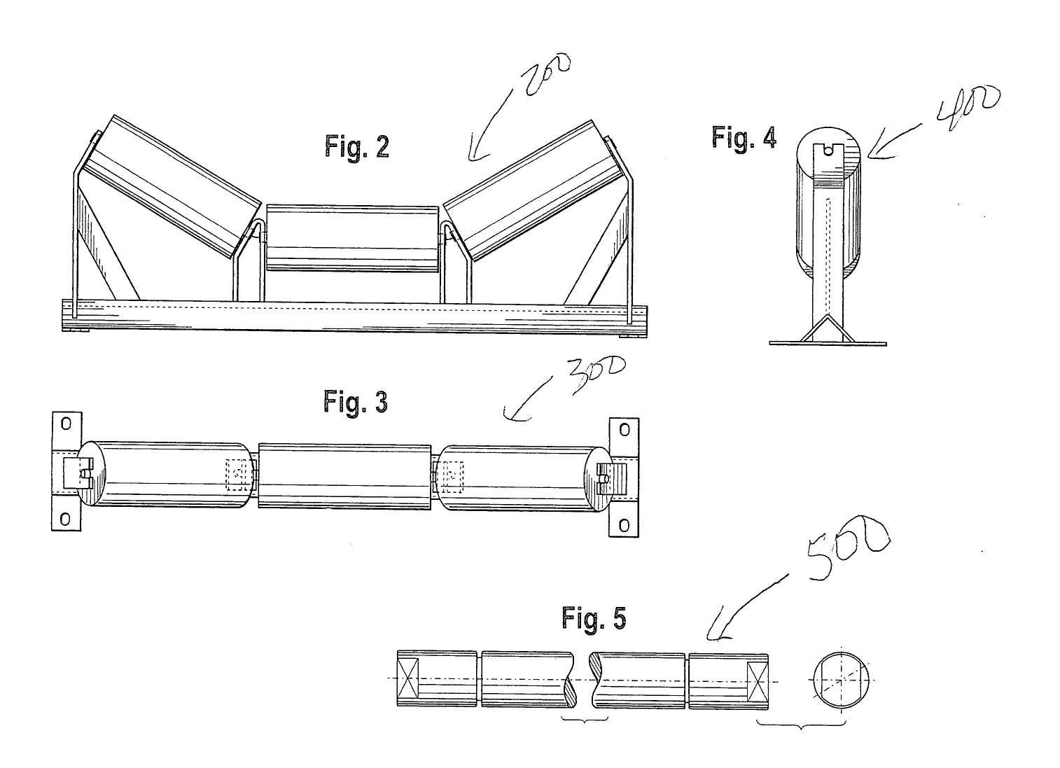

Although a number of low-weight polymers were considered, advantageously both cost savings and engineering suitability were found to be superior given the properties of engineering polymer UHMWPE, and consequently UHMWPE is the most suitable polymer for forming the conveyor roller, shown generally in carrying rollers illustrated at 200, 300, and 400 of FIGS. 2, 3, and 4, respectively, and a return-side roller 500 illustrated in FIG. 5, according to the principles of the present disclosure. UHMWPE material may be compression moulded or ram extruded to a desired shape. Since the requirements for a roller envisaged according to the principles of the present disclosure was pipe, an effort was made to extrude UHMWPE by conventional extrusion methods and that resulted in failure or degradation of the polymer material to HDPE, because of the extrusion process.

Efforts were made to redesign the screw of the extruder to reduce the shear rate during extrusion, based on the principle of compression/ram extrusion of dies in die design and sizing of pipe during extrusion.

As a result, the screw compression ratio was reduced to around 2.5:1 mm and the screw pitch to 60% of the screw diameter. The barrel was made with grooves throughout the entire length to maintain pressure during extrusion and to prevent slippage of material back toward a feed zone, instead of moving forward.

The UHMWPE raw material is available in powder form, hence special screw & die design was necessary. The material was again compounded in a high speed Henchel mixer to get required properties of extruded pipes. The raw material used in compounding were carbon black 5% and, for flow improvement, PE wax to the extent of 4% was added. The compounded material thus has antistatic properties as well as protection against aging and degradation. The entire mixture was discharged at a temperature of 98° C. to expel moisture, if any, present in the compounding ingredients. The hopper feeder was used to feed material into the extruder at a predetermined rate.

The die was redesigned to have higher heat inertia and compression ratio. As the resin melts from surface to centre of die, the centre of die is also heated through cartridge heaters to get uniform heating and uniform consolidation of matter, free from non-consolidated areas. The higher the consolidation of the material, the higher the resulting tensile strength.

The sizing & cooling of the pipe takes place in the die only. Then the length and the size of the die is critical for UHMWPE pipe extrusion. The last part of the die is made of brass, and cooled externally by an air ring. The pipe is also internally cooled at the die tip with highly pressurized air. Internal and external cooling sizes the pipe to required limits and not much further cooling is required.

The entire process of extrusion is very slow, and output for a 90 mm extruder is between 10 to 12 kgs. The line speeds of pipe produced are low and a small haul off, 3 jaw/4 jaw is used to maintain uniform speeds at such a low speed of formation of pipe.

The cutter used is a planetary type with provision for cutting pipe with an inner core.

The pipe cut by the cutter are removed manually and stacked.

Pipes made by this process were then cut to the required size by a band saw, and then bored to size and length on a special PLC controlled double-end boring machine.

The shaft of steel was replaced by a composite shaft made of glass fiber and resin. Different types of composite shafts were attempted, and it was discovered that a composite shaft made by boron free glass fibers gave very good acid resistance. Multi labyrinth nylon seals were re-designed to give optimum performance and to reduce weight.

The weight of a specially formulated polymer roller shell according to the principles herein is approximately ¼ the weight of a steel roller shell. The steel bearing housing welded at the ends of a steel shell were replaced with ABS molded housings and press fitted, thereby avoiding welding operation and residual stresses developed in the shell due to welding on it.

The overall reduction in the rotating mass was high, resulting in lower power consumption.

In accordance with the principles herein, the steel shaft of a conventional roller is replaced by a composite shaft, without affecting the structural and tensile strength of the shaft of the roller. The weight of the composite shaft is ⅓^{rd} the weight of the steel shaft. The composite shaft replaced was of the same size as the steel shaft, and was machined to a required tolerance and flattened at the ends for holding and locking the shaft to prevent rotation. The bearings used for embodiments constructed in accordance with the principles herein were the same as the bearings used in steel rollers.

In accordance with the principles herein, a shell of the roller is made from this material in special equipment to form a pipe with an internal profile of captive design i.e. with internal ribs—12 nos for pipes up to 139.9 OD and 16 nos for 152 and 159 OD pipes. The internal profile of the pipe gives better rigidity and tensile strength. Pipes are made antistatic, if desired. If required the pipes can be made fire retardant VO grade of U.L by adding suitable chemicals during compounding of the material.

The shaft of the material is made from epoxy resin and Advantex named boron free glass fiber poltruded to required size, offers excellent electrical corrosion resistance and higher mechanical properties. Epoxy resin offers excellent tensile strength and stiffness and tender high temperature—resistant. Poltrusion is a manufacturing process for producing continuous lengths of reinforced polymer structural shapes with constant cross-sections. The shaft can be machined and ground to achieve a proper fit, as required for bearing fitment. The material has very low density of 2.1 gms/cc. The tensile strength is the same as that of steel.

The troughing and return rollers of a conveyor made by using these materials have very low weight.

A comparison of the weight of rollers of the same diameter length made from steel and from the material identified in accordance with the principles herein is give below.

The size of the roller under comparison is OD 114.3 mm, length 380 mm, shaft diameter 20 mm×406 long with 14×9 flats at both ends to prevent rotation of shaft.

For example, a metal roller shell of M.S. pipe 114.3 mm Dia of 4.5 mm thickness, En 8 shaft of 25.3 mm Dia., bearing 6205 zz with nylon seal set, weighed 6.5 kgs.

An exemplary polymer roller shell constructed in accordance with the principles herein using UHMWPE pipe 114.3 Dia×7 mm thickness with ribbed internal profile, shaft of composite material 25.1 Dia, bearings 6205 zz with nylon seal set, weighed 1.82 kgs.

From the above examples, one can see that the weight of the polymer roller is substantially less than the weight of the metal steel rollers. Thus, the weight of rollers with the UHMWPE material of shell and composite shaft will be 20 to 25% of that of the steel roller of the same size. Longer rollers will have even greater reduction in weight.

I or we claim:

1. A light weight, non-stick, corrosion and wear resistant roller in conveyor systems moulded out of an engineering polymer material through screw extruder by formation of a barrel with grooves throughout the length embedded with a shaft of glass reinforced material, reducing total weight of the roller which result in lesser inertia of rotating elements, lesser overall weight hence lesser weight of supporting structure, lesser input power requirement and no material built up on rotating parts.

2. A light weight, non-stick, corrosion and wear resistant roller as claimed in claim 1, wherein the polymer material is made antistatic by adding suitable chemicals, such as, activated carbon black while compounding of raw material used in production of pipes of roller shell.

3. A light weight, non-stick, corrosion and wear resistant roller as claimed in claim 1, wherein the roller shaft is formed out of composite material made of resin and glass fiber poltruded in special equipment which ensures dimensional tolerance and straightness.

4. A conveyor system comprising:
a light weight, non-stick, corrosion and wear-resistant roller moulded out of an engineering polymer material, using a screw extruder, the roller including a shaft of glass reinforced material; and
a conveyor belt slidably mounted on the roller.
